(19) United States
(12) Patent Application Publication
(10) Pub. No.: US 2026/0158689 A1
(43) Pub. Date: Jun. 11, 2026

(54) RAZOR CARTRIDGE

(71) Applicant: DORCO CO., LTD., Seoul (KR)

(72) Inventors: Da Woon HAN, Seoul (KR); Ji Hun KI, Seoul (KR); Sang Hun PARK, Seoul (KR)

(21) Appl. No.: 19/179,552

(22) Filed: Apr. 15, 2025

Related U.S. Application Data
(63) Continuation of application No. PCT/KR2024/007022, filed on May 23, 2024.

(30) Foreign Application Priority Data
May 26, 2023 (KR) 10-2023-0068696
Jul. 21, 2023 (KR) 10-2023-0095160
May 10, 2024 (KR) 10-2024-0062164

(51) Int. Cl. B26B 21/22; B26B 21/40; B26B 21/44; B26B 21/56

(52) U.S. Cl. CPC B26B 21/222; B26B 21/4031; B26B 21/565; B26B 21/4018; B26B 21/443

(57) ABSTRACT

A razor cartridge is proposed. The cartridge may include at least one razor blade including a cutting edge. The cartridge may also include a blade housing forming an accommodation space configured to accommodate the razor blade in a longitudinal direction. The cartridge may further include a first fixing unit configured to support opposing sides of the razor blade, and a second fixing unit positioned on the upper part of the opposing sides of the razor blade and preventing the razor blade from disengaging from the blade housing. The cartridge may further include an opening forming a space between the first fixing unit and the second fixing unit and penetrating outward in the longitudinal direction.

### CROSS REFERENCE TO RELATED APPLICATIONS

This is a continuation application of International Patent Application No. PCT/KR2024/007022 filed on May 23, 2024, which claims priority to Korean patent application No. 10-2023-0068696 filed on May 26, 2023, Korean patent application No. 10-2023-0095160 filed on Jul. 21, 2023, and Korean patent application No. 10-2024-0062164 filed on May 10, 2024, contents of each of which are incorporated herein by reference in their entireties.

### BACKGROUND

### Technical Field

The disclosure relates to a razor cartridge, and more particularly to a razor cartridge with at least one razor blade accommodated therein.

### Description of Related Technology

In general, a razor refers to a product for cutting body hair such as fuzz and stubble on a face or body, and includes a razor handle for a grip, and a razor cartridge with a razor blade that comes into contact with skin to have a shave.

### SUMMARY

One aspect is a razor cartridge improved in efficiency of discharging shaving residues and/or enhancing cleaning performance.

The aspects of the disclosure are not limited to those described herein, and other aspects not mentioned above may become apparent to those skilled in the art from the following description.

Another aspect is a razor cartridge that includes: at least one razor blade formed with a cutting edge; a blade housing forming an receive space to accommodate the razor blade in a longitudinal direction; first fixing portions configured to support both sides of the razor blade; second fixing portions located above both sides of the razor blade and preventing the razor blade from being separated from the blade housing; and an opening forming a space between the first fixing portion and the second fixing portion and opened outward in the longitudinal direction.

Other details of the disclosure are included in the detailed description and the accompanying drawings.

According to the embodiments of the disclosure, the effects are at least as follows.

Shaving residues are discharged on both sides of a razor cartridge in a longitudinal direction, thereby improving the efficiency of discharging the shaving residues and the convenience of cleaning the razor cartridge.

The effects of the disclosure are not limited to those described above, and various other effects are included in the foregoing description.

### BRIEF DESCRIPTION OF THE DRAWINGS

FIG. 1 is a perspective view showing a razor cartridge according to an embodiment of the disclosure the razor cartridge.

FIG. 2 is an exploded perspective view showing a razor cartridge according to an embodiment of the disclosure.

FIG. 3 is a lateral view showing a razor cartridge according to an embodiment of the disclosure.

FIG. 4 is a cross-sectional view taken along line A-A in FIG. 1.

FIG. 5 is a lateral view showing a razor cartridge according to an embodiment of the disclosure without razor blades.

FIG. 6 is a lateral view schematically showing a razor blade of a razor cartridge according to an embodiment of the disclosure.

FIG. 7 is a lateral view schematically showing a razor blade according to an alternative embodiment.

FIG. 8 is a cross-sectional view showing a razor cartridge according to an embodiment of the disclosure without a clip.

FIG. 9 is a plan view showing a razor cartridge according to an embodiment of the disclosure.

FIG. 10 is a perspective view of a razor cartridge according to another embodiment of the disclosure.

FIG. 11 is an exploded perspective view showing a razor cartridge according to another embodiment of the disclosure.

FIG. 12 is a perspective view showing a razor cartridge according to still another embodiment of the disclosure.

FIG. 13 is an exploded perspective view of a razor cartridge according to still another embodiment of the disclosure.

### DETAILED DESCRIPTION

The razor cartridge accommodates a plurality of razor blades arranged adjacent to each other. Because a large gap between the razor blades may cause cuts on skin during a shaving process, the razor blades are arranged at narrow intervals of a few millimeters.

Shaving residues (cut hair, dead skin cells, shaving lubricant, etc.) generated during the shaving process are introduced between the razor blades. However, the gap between the razor blades is so narrow that a user needs to be careful to clean the razor blades thoroughly.

The merits and characteristics of the disclosure and a method for achieving the merits and characteristics will become more apparent from embodiments described below in detail in conjunction with the accompanying drawings. However, the disclosure is not limited to the disclosed embodiments, but may be implemented in various different ways. The embodiments are provided to only complete the disclosure and to allow those skilled in the art to understand the category of the disclosure. The disclosure is defined by the category of the claims.

In addition, embodiments of the disclosure will be described with reference to cross-sectional views and/or schematic views as idealized exemplary illustrations. Therefore, the illustrations may be varied in shape depending on manufacturing techniques, tolerance, and/or etc. Further, elements in the drawings may be relatively enlarged or reduced for convenience of description. Like numerals refer to like elements throughout.

Further, first, second, i), ii), a), b) and the like terms may be used in describing elements according to embodiments of the disclosure. Such terms are used solely for the purpose of differentiating one element from another, but not limit the substances, the order, sequence, etc. of those elements. Throughout this specification, when a part ‘includes’ or ‘comprises’ an element, the part is meant to further include other elements rather than excluding other elements unless otherwise stated explicitly.

Below, a razor cartridge according to embodiment of the disclosure will be described with reference to the accompanying drawings.

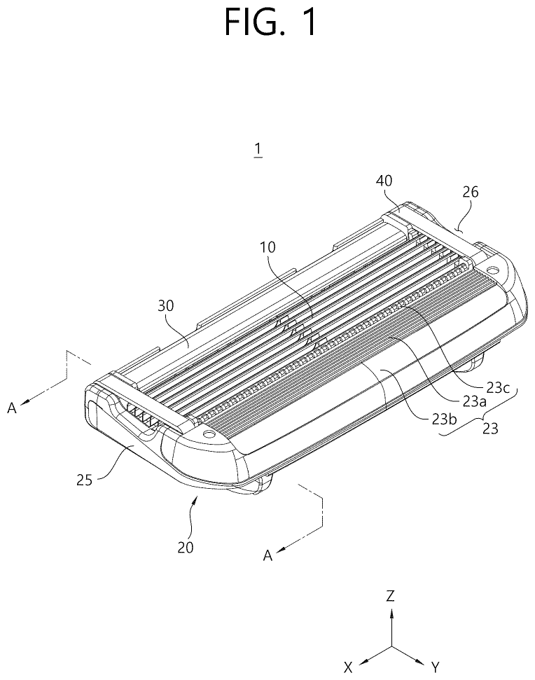

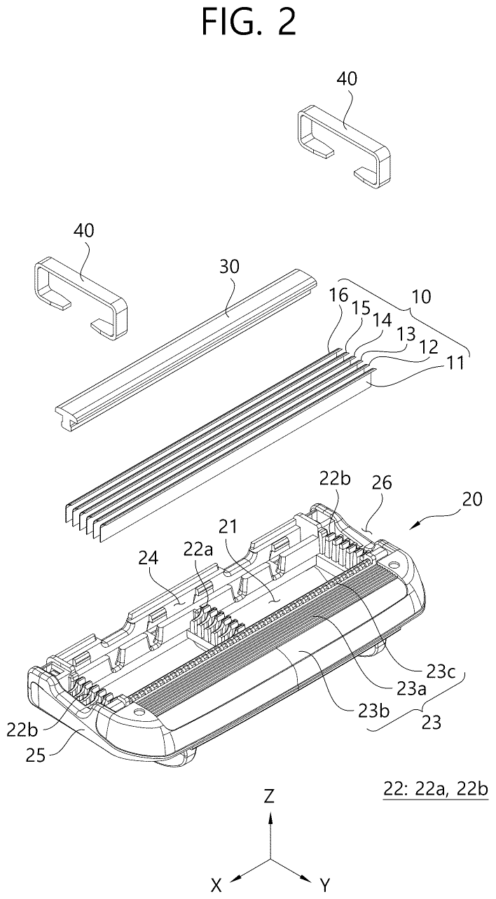

FIG. 1 is a perspective view showing a razor cartridge according to an embodiment of the disclosure the razor cartridge, and FIG. 2 is an exploded perspective view showing a razor cartridge according to an embodiment of the disclosure.

Referring to FIGS. 1 and 2, the razor cartridge 1 according to an embodiment of the disclosure includes a plurality of razor blades 10, and a blade housing 20.

Referring to FIG. 2, the blade housing 20 includes an accommodating space 21 formed in a central portion thereof to receive the plurality of razor blades 10 in a longitudinal direction (the X-axis direction). FIGS. 1 and 2 show an example that the razor cartridge 1 includes six razor blades 11 to 16, but the number of razor blades 10 may vary depending on embodiments.

FIG. 2 shows an example that the blade housing 20 is configured as one part, but the blade housing 20 may be configured as a plurality of parts according to embodiments. For example, the blade housing may include a main frame to receive the plurality of razor blades 10, and a sub frame coupled to the main frame and at least partially surrounding the main frame. A guard portion 23 and a lubrication band 30, as described below, may be at least partially provided in the sub frame. Further, the sub frame may be configured to include at least one of a first fixing portion 25 and a second fixing portion 40.

The accommodating space 21 may be formed to penetrate the blade housing 20 vertically so that the shaving residues introduced between the plurality of razor blades 10 can be easily discharged.

The top surface of the blade housing 20, as described below, refers to a surface that comes into contact with a user's skin or faces a user's skin during a shaving process. The upper direction of the blade housing 20 refers to a direction (the positive Z-axis direction) in which the top surface faces. The bottom surface of the blade housing 20 refers to an opposite surface to the top surface. The lower direction of the blade housing 20 refers to a direction (the negative Z-axis direction), in which the bottom surface faces, i.e., an opposite direction to the upper direction. The front direction of the blade housing 20 refers to a direction (a shaving direction, i.e., the positive Y-axis direction) in which the blade housing 20 advances relative to a user's skin during the shaving process, and the back direction of the blade housing 20 refers to an opposite direction (the negative Y-axis direction) to the front direction.

Referring to FIG. 2, the blade housing 20 may include a razor blade mounting portion 22 to which the plurality of razor blades 10 are received. The razor blade mounting portion 22 may include a first razor blade mounting portion 22a and a second razor blade mounting portion 22b.

The first razor blade mounting portion 22a may accommodate and/or support the central portion of the plurality of razor blades 10, and the second razor blade mounting portion 22b may accommodate and/or support both sides of the plurality of razor blades 10. The first razor blade mounting portion 22a may be formed to cross the accommodating space 21 in a transverse direction. The second razor blade mounting portion 22b may be formed on both sides of the accommodating space 21 in the longitudinal direction. The first razor blade mounting portion 22a and the second razor blade mounting portion 22b may be configured to elastically support the plurality of razor blades 10.

The blade housing 20 may exclude the first razor blade mounting portion 22a according to an embodiment. In this case, the plurality of razor blades 10 may be accommodated in and/or supported by the second razor blade mounting portion 22b on both sides.

The blade housing 20 includes the guard portion 23 provided in the front direction of the accommodating space 21. The guard portion 23 refers to a portion that comes into contact with skin before the razor blades 10 during the shaving process, thereby providing functions such as pulling the skin, aligning body hair, or removing foreign substances on the skin.

For example, the guard portion 23 may include an elastic guard 23a. The elastic guard 23a pulls the skin while being in close contact with a user's skin during the shaving process, thereby improving the shaving effect of the razor blades 10. In order for the elastic guard 23a to more effectively pull a user's skin, the top surface of the elastic guard 23a may be formed with an embossed or engraved pattern, and may be made of a material such as rubber or silicone.

For example, the guard portion 23 may include a hard guard 23b. The hard guard 23b removing foreign substances (for example, dead skin cells, excessively applied shaving lubricant, etc.) present on a user's skin during the shaving process, thereby improving the shaving effect. In order for the hard guard 23b to improve the effect of removing the foreign substances, fine unevenness may be formed on the top surface of the hard guard 23b. As shown in FIGS. 1 and 2, the hard guard 23b may be placed in front of the elastic guard 23a. In this case, the hard guard 23b first comes into contact with the skin to remove foreign substances on the skin, and the elastic guard 23a then comes into close contact with the skin, from which the foreign substances have been removed, to pull the skin.

For example, the guard portion 23 may include a comb guard 23c. The comb guard 23c aligns body hair before the body hair is cut by the razor blades 10, thereby improving the shaving effect. The comb guard 23c may include uneven patterns spaced apart from each other in the longitudinal direction perpendicular to the shaving direction so that the body hair can be aligned with the shaving direction. As shown in FIGS. 1 and 2, the comb guard 23c may be placed between the elastic guard 23a and the accommodating space 21, and may be placed in front of a first razor blade 11 located at the frontmost line among the plurality of razor blades 10.

It has been described by way of example with reference to FIGS. 1 and 2 that the guard portion 23 includes the elastic guard 23a, the hard guard 23b and the comb guard 23c, but the guard portion 23 may include at least one of the elastic guard 23a, the hard guard 23b, and the comb guard 23c. According to an embodiment, the guard portion 23 may further include a configuration that provides additional functions (for example, heating, light irradiation, fluid spray, etc.) for the shaving.

Referring to FIG. 2, the razor cartridge 1 according to an embodiment may further include the lubrication band 30, and the blade housing 20 may include a lubrication band accommodating groove 24 provided behind the accommodating space 21 and allowing the lubrication band 30 to be installed thereon. The lubrication band 30 may be installed so that an upper surface thereof can be exposed to the top surface of the blade housing 20. The lubrication band 30 contains a lubricating material and applies the lubricating material to a skin surface where the razor blades 10 have passed during the shaving process. The lubricating material may contain ingredients to protect the skin after shaving.

A plane connecting the top surface of the guard portion 23 and the top surface of the lubrication band 30 may be defined as a shaving plane. The lubrication band 30 may be excluded, and in this case, the shaving plane may be defined as a plane connecting a cap portion (not shown) located behind the accommodating space 21 and the top surface of the guard portion 23. The shaving plane refers to an imaginary plane where the razor cartridge 1 is considered to be in contact with skin at the same time. The cutting edge of the razor blade 10 may be adjacent to the shaving plane, and at least some razor blades 10 may be located below or above the shaving plane. For example, the razor blades located in a front portion among the razor blades 10 are arranged with their cutting edges having a negative protrusion value corresponding to the location below the shaving plane to prevent skin cuts, the razor blades located in a back portion among the razor blades 10 are arranged with their cutting edges having a positive protrusion value corresponding to the location above the shaving plane to have a cleaner shave, and the razor blades located in a center portion among the razor blades 10 are arranged with their cutting edges having a zero protrusion value corresponding to the shaving plane.

Referring to FIGS. 1 and 2, the razor cartridge 1 includes the first fixing portion 25 configured to laterally support both sides of the plurality of razor blades 10. FIGS. 1 and 2 shows an example that the first fixing portion 25 is configured integrally with the blade housing 20, but the first fixing portion 25 may also be configured separately from the blade housing 20. When the blade housing includes the main frame that accommodates the plurality of razor blades 10 and the sub frame located on both sides of the main frame in the longitudinal direction, the first fixing portion 25 may be formed in the sub frame.

The first fixing portion 25 is provided outside the second razor blade mounting portion 22b in the longitudinal direction to prevent the razor blades 10 from being separated outward. The second razor blade mounting portion 22b may be formed extending from the first fixing portion 25 toward the accommodating space 21.

Further, referring to FIGS. 1 and 2, the razor cartridge 1 includes the second fixing portion 40 at least partially located above both sides of the plurality of razor blades 10 to prevent the razor blades 10 from being separated through the top surface of the blade housing 20. FIGS. 1 and 2 show a clip as an example of the second fixing portion 40, but the second fixing portion 40 according to an embodiment may be provided in the blade housing 20 to cover the upper portions of the razor blades 10 on the both sides. Alternatively, when the blade housing includes the main frame accommodating the plurality of razor blades 10 and the sub frame surrounding at least a portion of the main frame, the second fixing portion 40 may be formed in the main frame or the sub frame provided to cover the upper portions of the main frame on the both sides. Alternatively, even though the blade housing includes the main frame and the sub frame, the second fixing portion 40 may be provided as a separate clip.

For stably support both sides of the razor blades 10 in the vertical direction, the second fixing portion 40 may be located above the second razor blade mounting portion 22b. In other words, the second fixing portion 40 and the second razor blade mounting portion 22b may be arranged to at least partially overlap in the vertical direction.

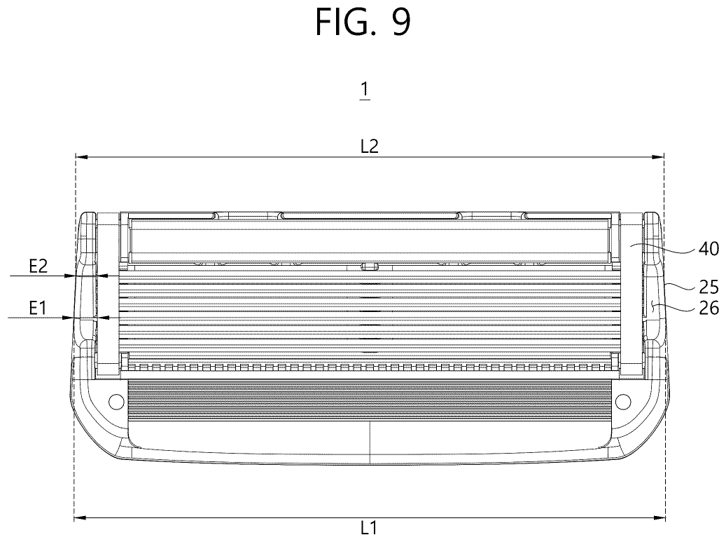

Because the first fixing portion 25 is located outside the second razor blade mounting portion 22b in the longitudinal direction, the second fixing portion 40 and the first fixing portion 25 may not overlap in the vertical direction (see FIG. 9). In this case, the first fixing portion 25 and the second fixing portion 40 may be substantially located to be immediately adjacent to each other in the longitudinal direction. However, according to an embodiment, the first fixing portion 25 and the second fixing portion 40 may be configured to overlap at least partially with each other in the vertical direction. As the first fixing portion 25 and the second fixing portion 40 are located to be immediately adjacent to each other in the longitudinal direction or to overlap at least partially with each other in the vertical direction, both sides of the razor blades 10 are more firmly supported, and the exposure of the razor blades 10 on both sides to the top of the razor cartridge 1 can be minimized, thereby preventing a user from being cut by the razor blades 10 while holding the razor cartridge 1.

Referring to FIGS. 1 and 2, the razor cartridge 1 includes an opening 26 forming a space between the first fixing portion 25 and the second fixing portion 40 and opened outward in the longitudinal direction. The opening 26 may be opened toward the accommodating space 21. The shape and/or size of the opening 26 observed from both sides of the razor cartridge 1 in the longitudinal direction may vary depending on the first fixing portion 25 and the second fixing portion 40. For example, the shape of the opening 26 may be defined by the shapes of the top surface of the first fixing portion 25 and the bottom surface of the second fixing portion 40. The depth of the opening 26 may be defined as a height direction (Z-axis direction) distance between the first fixing portion 25 and the second fixing portion 40 at the corresponding location.

The opening 26 allows the shaving residues present between the razor blades 10 to be discharged even in lateral directions during the shaving process and/or cleaning process, thereby improving the efficiencies of discharging the shaving residues and the convenience of cleaning the razor cartridge 1.

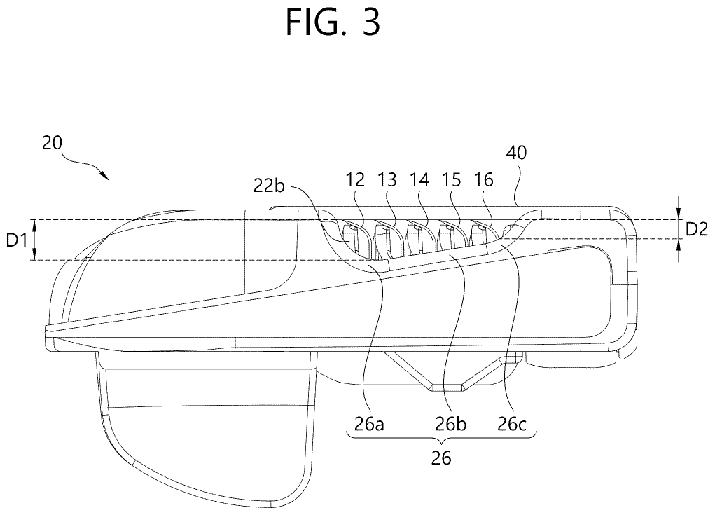

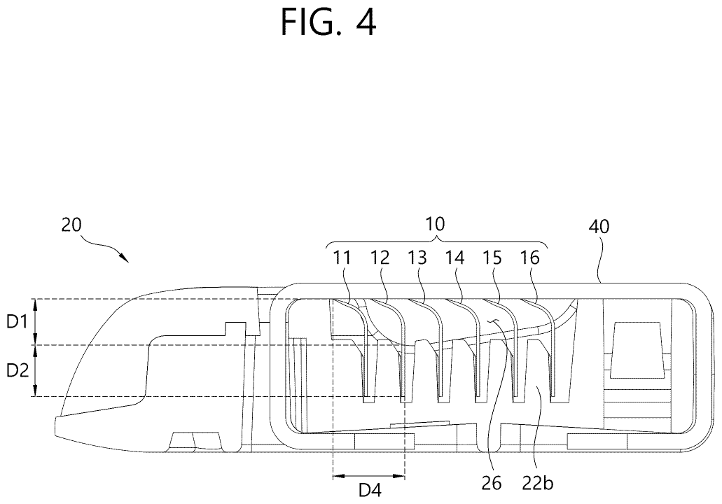

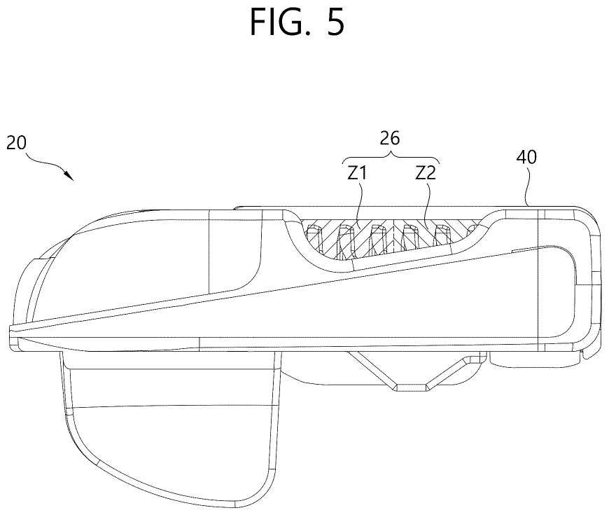

FIG. 3 is a lateral view showing a razor cartridge according to an embodiment of the disclosure, FIG. 4 is a cross-sectional view taken along line A-A in FIG. 1, and FIG. 5 is a lateral view showing a razor cartridge according to an embodiment of the disclosure without the razor blades.

Referring to FIG. 3, the opening 26 may be opened toward the accommodating space 21 so that the razor blades 10 can be exposed at least partially. Further, the opening 26 may be formed expose the razor blades 12 to 16 at different heights.

For example, the opening 26 may be formed so that the exposure height of the plurality of razor blades 11 to 16 exposed through the opening 26 can decrease from the razor blades 13 and 14 located in the center portion toward the razor blades 15 and 16 located in the back portion. The maximum depth D1 of the opening 26 may be formed in front of the razor blades 13 and 14 located in the center portion. The point where the maximum depth D1 of the opening 26 is formed may be located ahead of the center of the opening 26.

Among all the razor blades, one razor blade (in the case of an odd number of total razor blades) or two razor blades (in the case of an even number of total razor blades) may be located in the center portion, and the razor blades located in the back portion may be the razor blades located behind the razor blade located in the center portion. Further, the razor blade located in the center portion may be the (N−1)/2, N/2 or (N+1)/2th razor blade from the front among N razor blades.

Referring to FIG. 5, the point where the maximum depth D1 of the opening 26 is formed is located ahead of the center of the opening 26, so that a front portion Z1 and a back portion Z2 divided based on the center portion of the opening 26 can be formed asymmetrically. An area ratio of the front portion Z1 to the back portion Z2 may be 1.1 to 1.8.

In general, a user grasps the razor cartridge 1 while holding both sides thereof with his/her fingers in the longitudinal direction. This is because the cutting edges of the razor blades 10 are exposed to the top surface of the razor cartridge 1, and the cutting edge of a trimmer blade included in the razor cartridge is exposed to the bottom surface of the razor cartridge in the back direction.

As described above, the razor cartridge 1 according to this embodiment includes the opening 26 opened on both sides in the longitudinal direction. The larger the area of the opening 26, the greater the efficiencies of discharging the shaving residues and cleaning of the razor cartridge 1. However, the larger area of the opening 26 decreases the area that a user can use to grasp the razor cartridge 1, thereby causing inconvenience for a user to grasp the razor cartridge 1.

Accordingly, the razor cartridge 1 according to this embodiment includes the opening 26, the height of which decreases toward the razor blades 15 and 16 located in the back portion, thereby preventing a user from experiencing much inconvenience when holding the razor cartridge 1.

In general, the amount and length of hair cut by the razor blades located in the front portion are greater than those of hair cut by the razor blades located in the back portion. Therefore, even though the opening 26 is formed to have a smaller height backward, the shaving residues are discharged smoothly. Referring to FIG. 3, the opening 26 may be formed so that its height from the second fixing portion 40 can decrease backward from the center portion.

Meanwhile, referring to FIGS. 3 and 4, the opening 26 may be formed behind the first razor blade 11 located in the frontmost line among the razor blades 10. In other words, the first razor blade 11 may not be exposed through the opening 26. The span of the first razor blade 11 refers to a gap between the cutting edge of the first razor blade 11 and the guard portion 23, and is longer than the spans of the other razor blades 12 to 16 (gaps between their cutting edges and the cutting edge of the razor blade located at the front). Therefore, even though the opening 26 is formed not to expose the first razor blade 11 to the outside in the longitudinal direction, the shaving residues caused by the first razor blade 11 are smoothly discharged through the accommodating space 21. Because the opening 26 does not extend to the outside of the first razor blade 11 in the longitudinal direction, a user can hold the razor cartridge 1 more stably. However, according to an embodiment, the opening 26 may be formed to expose at least a portion of the first razor blade 11.

The maximum depth D1 of the opening 26 may be formed adjacent to the second razor blade 12 located second from the front. Therefore, a relatively large amount of the shaving residues generated between the first razor blade 11 and the second razor blade 12 or between the second razor blade 12 and the third razor blade 13 are easily discharged through the opening 26. The maximum depth D1 of the opening 26 may be 0.92 mm to 1.4 mm, and preferably 1.02 mm to 1.28 mm. The maximum depth D1 of the opening 26 may mean the maximum height of the razor blade exposed through the opening 26 among the plurality of razor blades 10.

Referring to FIG. 3, the opening 26 may be divided into a front region 26a and a central region 26b with respect to the point where the maximum depth D1 is formed.

At least a portion of the front region 26a may be formed to increase the depth backwards. At least a portion of the front region 26a may be formed to increase the depth nonlinearly backwards.

At least a portion of the central region 26b may be formed to decrease the depth backwards. At least a portion of the central region 26b may be formed to decrease the depth linearly backwards. Referring to FIG. 3, the central region 26b may extend from the point where the maximum depth D1 is formed to the point adjacent to the razor blade 16 located in the rearmost line.

Referring to FIG. 3, the opening 26 may further include a back region 26c formed behind the central region 26b and at least partially decreasing the depth nonlinearly backwards.

The minimum height D2 of the razor blade exposed through the opening 26 among the plurality of razor blades 10 may be 0.48 mm to 0.72 mm, and preferably 0.52 mm to 0.65 mm.

Referring to FIG. 3, the area of the opening 26 (i.e., the two-dimensional area based on the lateral view (FIG. 3)) may be 9.0 mm² to 33 mm², and preferably 11 mm² to 25 mm². The lateral area of the razor cartridge 1 (i.e., the two-dimensional area based on the lateral view (FIG. 3)) may be 115 mm² to 180 mm², and preferably 120 mm² to 160 mm². The area proportion of the opening 26 to the lateral side of the razor cartridge 1 may be 6.5% to 10%.

Referring to FIG. 4, a distance D3 from the point where the maximum depth D1 of the opening 26 is formed to the bottom of the razor blades 10 or the bottom of the second razor blade mounting portion 22b may be 1.16 mm to 1.74 mm, and preferably 1.25 mm to 1.60 mm.

Referring to FIG. 4, the point where the maximum depth D1 of the opening 26 is formed may be spaced apart from the cutting edge of the first razor blade 11 backwards by D4. D4 may be 1.75 mm to 2.58 mm, and preferably 1.9 mm to 2.3 mm.

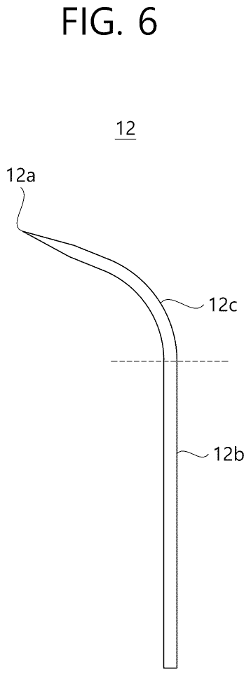

FIG. 6 is a lateral view schematically showing a razor blade of a razor cartridge according to an embodiment of the disclosure.

Referring to FIG. 6, the razor blade 12 may include a cutting edge 12a, a base portion 12b, and a bent portion 12c. The base portion 12b is accommodated in the first razor blade mounting portion 22a and the second razor blade mounting portion 22b, and the bent portion 12c is bent from the base portion 12b frontwards. Referring to FIG. 6, the boundary between the bent portion 12c and the base portion 12b is marked with a dotted line. The cutting edge 12a, the base portion 12b, and the bent portion 12c may be formed as a single body. The second razor blade 12 has been described as a representative, but other razor blades 11, and 13 to 16 may also have the same or similar configuration as the second razor blade 12.

As shown in FIG. 6, the cutting edge 12a may be formed at the end of the bent portion 12c.

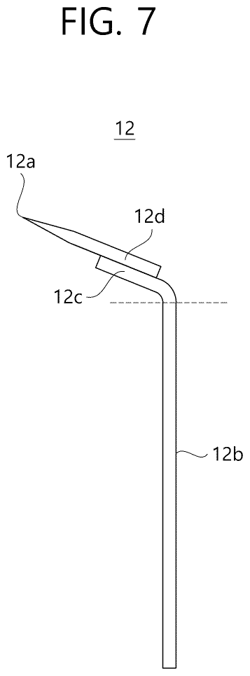

FIG. 7 is a lateral view schematically showing a razor blade according to an alternative embodiment.

Referring to 7, the razor blade 12 may be a welded blade in which a separate blade 12d formed with a cutting edge 12a is attached to a bent portion 12c bent and extended from the base portion 12b frontwards. Referring to FIG. 7, the boundary between the bent portion 12c and the base portion 12b is marked with a dotted line. The second razor blade 12 has been described as a representative, but other razor blades 11, and 13 to 16 may also have the same or similar configuration as the second razor blade 12. Below, for the convenience of description, the description is based on the razor blade 12 shown in FIG. 6, but the razor blade 12 shown in FIG. 7 may also be applied thereto.

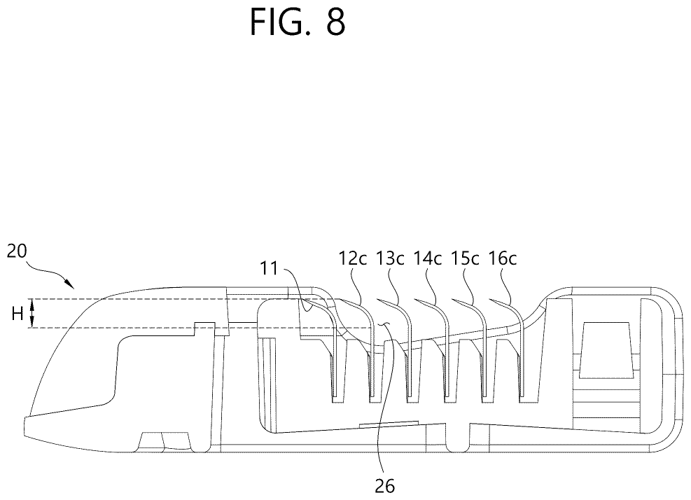

FIG. 8 is a cross-sectional view showing a razor cartridge according to an embodiment of the disclosure without a clip.

Referring to FIGS. 3 and 8, at least some of the razor blades 12 to 16 exposed through the opening 26 may include the cutting edges and the bent portions 12c to 16c exposed through the opening 26.

In general, the shaving residues are likely to accumulate in the bent portions 12c to 16c. However, the opening 26 is formed to expose the cutting edges and the bent portions 12c to 16c, so that the shaving residues can be effectively discharged through the opening 26. Further, to more effectively discharge the shaving residues, at least some of the razor blades 12 to 16 may include the base portions exposed through the opening 26.

Referring to FIG. 8, the height H from the boundary between the bent portion 12c to 16c and the base portion to the cutting edge may be 0.6 mm to 0.9 mm, preferably 0.62 mm to 0.83 mm, and more preferably 0.65 mm to 0.8 mm.

The ratio of the maximum depth D1 of the opening 26 to the height H from the boundary between the bent portion 12c to 16c and the base portion to the cutting edge may be 1 to 3, and preferably 1 to 2.5.

FIG. 9 is a plan view showing a razor cartridge according to an embodiment of the disclosure.

Referring to FIG. 9, the longitudinal width E1 of the first fixing portion 25 at the point corresponding to the maximum depth of the opening 26 may be formed to be wider than the longitudinal width E2 of the first fixing portion 25 in the central region 26b and/or back region 26c of the opening 26.

When a user grasps both sides the razor cartridge 1 in the longitudinal direction, his/her skin is highly likely to enter the accommodating space 21 through the opening 26 because the height of the opening 26 at the point where the maximum depth of the opening 26 is formed is greater than that in the central region 26b and/or back region 26c. Therefore, the longitudinal width E1 of the first fixing portion 25 at the point corresponding to the maximum depth of the opening 26 is formed to be wider than those at the other points of the opening 26, thereby preventing skin cuts by the razor blades 10 even though a user's skin enters the accommodating space 21 at the point where the maximum depth of the opening 26 is formed.

Similarly, the longitudinal width L1 of the blade housing 20 at the point where the maximum depth of the opening 26 is formed may be formed to be wider than the longitudinal width L2 of the blade housing 20 in the central region 26b and/or back region 26c of the opening 26.

Below, a razor cartridge according to another embodiment will be described. For convenience of description, the same numerals will be used for elements similar to those of the foregoing embodiment, and descriptions common to those of the foregoing embodiment will be omitted.

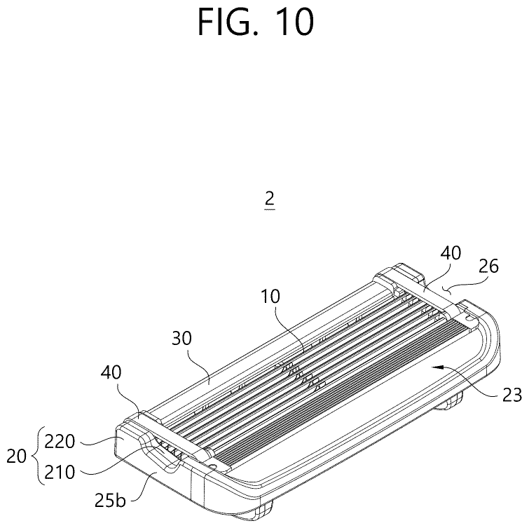

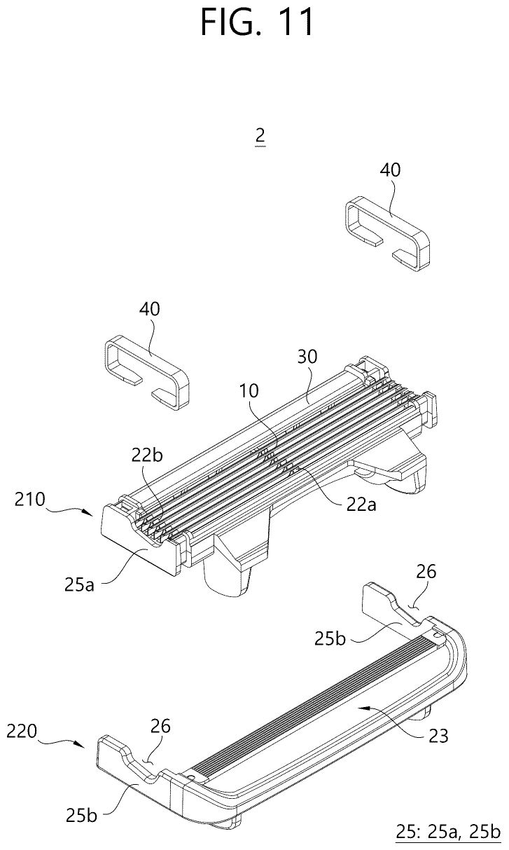

FIG. 10 is a perspective view of a razor cartridge according to another embodiment of the disclosure, and FIG. 11 is an exploded perspective view showing a razor cartridge according to another embodiment of the disclosure.

Referring to FIGS. 10 and 11, a razor cartridge 2 according to this embodiment of the disclosure is different from the razor cartridge 1 according to the foregoing embodiment in that the blade housing 20 includes a main frame 210 and a sub frame 220.

Referring to FIG. 11, the main frame 210 accommodates the plurality of razor blades 10. The first razor blade mounting portion 22a and/or the second razor blade mounting portion 22b may be formed in the main frame 210.

The main frame 210 may accommodate the lubrication band 30 located behind the plurality of razor blades 10. However, according to an embodiment, the lubrication band 30 may be provided in the sub frame 220 (to be described later).

The second fixing portion 40 may be coupled to the main frame 210 so as to prevent the razor blades 10 from being separated from the main frame 210 while interfering with both sides of the plurality of razor blades 10. FIG. 11 shows a clip as an example of the second fixing portion 40. However, the second fixing portion 40 is not limited to the clip, but may employ various configurations to prevent the razor blades 10 from being separated from the main frame 210.

Referring to FIGS. 10 and 11, the sub frame 220 may be coupled to the main frame 210 while surrounding the front and lateral portions of the main frame 210. The guard portion 23 and the first fixing portion 25b may be formed in the sub frame 220. The guard portion 23 may be formed in the sub frame 220 so that the guard portion 23 can be located in front of the main frame 210. The first fixing portion 25b may extend from both sides of the guard portion 23 backwards so as to be located on both sides of the main frame 210 in the longitudinal direction.

Referring to FIGS. 10 and 11, the razor cartridge 2 according to this embodiment also includes the opening 26 forming a space between the first fixing portion 25b and the second fixing portion 40 and opened outward in the longitudinal direction. The opening 26 has been described in detail in the foregoing embodiment, and thus repetitive descriptions thereof will be omitted.

Referring to FIG. 11, the first fixing portion 25 may include a first outer fixing portion 25b formed in the sub frame 220, and a first inner fixing portion 25a formed in the main frame 210. The first outer fixing portion 25b and the first inner fixing portion 25a may be shaped corresponding to each other to form the opening 26 together.

Because the second fixing portion 40 is provided in the main frame 210, the first inner fixing portions 25a are formed on both sides of the main frame 210 so that the first fixing portion 25 and the second fixing portion 40 can be located adjacent to each other in the longitudinal direction, thereby forming the opening 26. However, according to an embodiment, the first inner fixing portion 25a may be excluded.

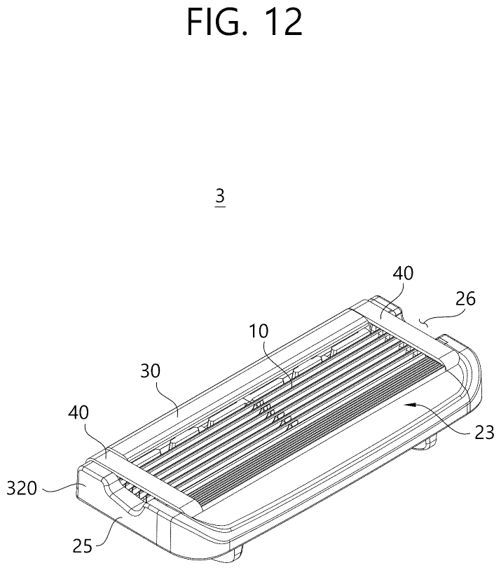

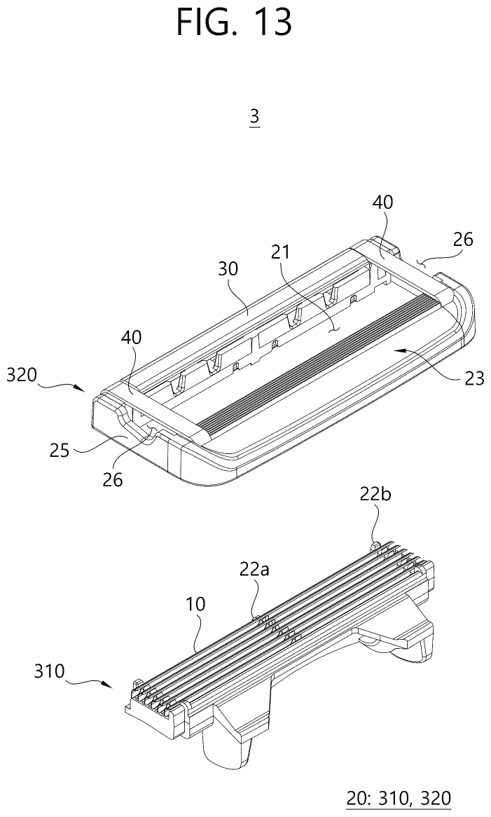

FIG. 12 is a perspective view showing a razor cartridge according to still another embodiment of the disclosure, and FIG. 13 is an exploded perspective view of a razor cartridge according to still another embodiment of the disclosure.

Referring to FIGS. 12 and 13, a razor cartridge 3 according to this embodiment of the disclosure is different from the razor cartridge 2 according to the embodiment described with reference to FIGS. 10 and 11 in that the second fixing portion 40 is formed in a sub frame 320.

The blade housing 20 according to this embodiment also includes a main frame 310 and the sub frame 320.

The main frame 310 accommodates the plurality of razor blades 10, and the first razor blade mounting portion 22a and/or the second razor blade mounting portion 22b may be formed in the main frame 310.

Referring to FIGS. 12 and 13, the sub frame 320 may be formed to form the accommodating space 21 at the center portion and surround the accommodating space 21 on all sides. The sub frame 320 may be coupled to the main frame 310 while surrounding the main frame 310 so that the plurality of razor blades 10 provided in the main frame 310 can be exposed to the outside through the upper portion of the accommodating space 21.

The guard portion 23 may be formed in the sub frame 320 so as to be located in front of the accommodating space 21. The lubrication band 30 may be formed in the sub frame 320 so as to be located behind the accommodating space 21.

The second fixing portion 40 may be formed in the sub frame 320 so as to be located above both sides of the plurality of razor blades 10. The second fixing portion 40 may be formed integrally with the sub frame 320. The second fixing portion 40 may be formed to cross both sides of the accommodating space 21 in the transverse direction. The second fixing portion 40 may be formed for connection between a cap portion on which the lubrication band 30 is formed and the guard portion 23. According to an embodiment, the second fixing portion 40 may be configured as a clip assembled to the main frame 310 and/or the sub frame 320.

The first fixing portion 25 may be formed in the sub frame 320 so as to be located on both sides of the plurality of razor blades 10.

Referring to FIGS. 12 and 13, the sub frame 320 includes the opening 26 forming a space between the first fixing portion 25b and the second fixing portion 40 and opened from the accommodating space 21 outwards in the longitudinal direction. The opening 26 has been described in detail in the foregoing embodiment, and thus repetitive descriptions thereof will be omitted.

As described above, the razor cartridge 1, 2 or 3 according to the embodiment of the disclosure includes the opening 26 formed between the first fixing portion 25 and the second fixing portion 40 on both sides in the longitudinal direction, thereby improving the efficiency of discharging the shaving residues and the convenience of cleaning the razor cartridge 1, 2 or 3.

Further, the opening 26 is formed to have a smaller height backwards, thereby minimizing inconvenience when a user grasps the razor cartridge 1, 2 or 3.

Further, the point where the maximum depth of the opening 26 is formed is located in front of the center portion of the opening 26, thereby effectively discharging a relatively large amount of shaving residues generated in the razor blades located in the front portion.

Further, the opening 26 is formed to expose the bent portion of the razor blade, so that the shaving residues accumulated in the bent portion can be effectively discharged through the opening 26.

Further, the longitudinal widths of the first fixing portion 25, the blade housing 20 and/or the razor cartridge 1, 2 or 3 at the point where the maximum depth of the opening 26 is formed are formed to be wider than the longitudinal widths of the first fixing portion 25, the blade housing 20 and/or the razor cartridge 1, 2 or 3 in the central region 26b and the back region 26c of the opening 26, thereby preventing cuts on a user's skin.

A person having ordinary knowledge in the art to which the disclosure pertains can understood that the disclosure may be embodied in other specific forms without changing technical spirit or essential features. Accordingly, the embodiments described above are illustrative and not restrictive in all aspects. The scope of the disclosure is defined by the appended claims rather than the foregoing detailed description, and all changes or modifications derived from the meaning and scope of the appended claims and their equivalents are construed as falling within the scope of the disclosure.

What is claimed is:

1. A razor cartridge comprising:
at least one razor blade comprising a cutting edge;
a blade housing forming an accommodating space configured to receive the razor blade in a longitudinal direction;
a first fixing portion configured to support opposing sides of the razor blade;
a second fixing portion located above the opposing sides of the razor blade and configured to prevent the razor blade from being separated from the blade housing; and
an opening forming a space between the first fixing portion and the second fixing portion and opened outward in the longitudinal direction.

2. The razor cartridge of claim 1, wherein the opening is opened toward the accommodating space to expose at least a portion of the razor blade.

3. The razor cartridge of claim 2, wherein:
the razor blade comprises a plurality of razor blades, and
the opening is formed so that the plurality of razor blades are different in exposure height from one another.

4. The razor cartridge of claim 2, wherein:
the razor blade comprises a plurality of razor blades, and
the opening is formed so that height, by which the plurality of razor blades are exposed through the opening, decreases in at least a portion of a region from central razor blades located in a center portion of the accommodating space of the blade housing among the plurality of razor blades toward back razor blades located behind the central razor blades.

5. The razor cartridge of claim 1, wherein the opening includes a front region where depth increases backwards in at least a portion of a region, and a back region where depth decreases backwards in at least a portion of a region.

6. The razor cartridge of claim 1, wherein the opening has a maximum depth of 0.9 mm to 1.4 mm.

7. The razor cartridge of claim 5, wherein a point where the maximum depth of the opening is formed is located in front of the center portion of the opening.

8. The razor cartridge of claim 5, wherein a longitudinal width of the blade housing at a point where the maximum depth of the opening is formed is wider than a longitudinal width of the blade housing at a point where the back region is formed.

9. The razor cartridge of claim 5, wherein a longitudinal width of the first fixing portion at a point where the maximum depth of the opening is formed is wider than a longitudinal width of the first fixing portion at a point where the back region is formed.

10. The razor cartridge of claim 5, wherein:
the opening further includes a central region connecting the front region and the back region and configured to linearly decrease in depth backwards, and
the back region is configured to nonlinearly decrease in depth backwards.

11. The razor cartridge of claim 5, wherein the front region is configured to nonlinearly increase in depth backwards.

12. The razor cartridge of claim 1, wherein:
the razor blade comprises a plurality of razor blades, and
the opening is formed behind the razor blade located in a frontmost line among the plurality of razor blades.

13. The razor cartridge of claim 1, wherein:
the razor blade comprises N razor blades, and
a maximum depth of the opening is formed in front of the (N−1)/2, N/2 or (N+1)/2th razor blade from the front among N razor blades.

14. The razor cartridge of claim 1, wherein:
the razor blade further includes a base portion supported by the first fixing portion, and a bent portion bent from the base portion frontwards, and
the cutting edge and the bent portion are exposed through the opening.

15. The razor cartridge of claim 14, wherein a ratio of a maximum depth of the opening to a height from a boundary between the bent portion and the base portion to a cutting edge is 1 to 3.

16. The razor cartridge of claim 1, wherein at least a portion of the first fixing portion and at least a portion of the second fixing portion do not overlap in a vertical direction.

17. The razor cartridge of claim 1, wherein the first fixing portion and the second fixing portion are located to be immediately adjacent to each other in the longitudinal direction.

18. The razor cartridge of claim 1, wherein the opening includes a front portion and a back portion formed asymmetrically with respect to a center portion.

19. The razor cartridge of claim 18, wherein an area ratio of the front portion to the back portion is 1.1 to 1.8.

20. The razor cartridge of claim 1, wherein:
the blade housing includes a razor blade mounting portion to accommodate the opposing sides of the razor blade, and
the first fixing portion is provided outside the razor blade mounting portion in the longitudinal direction.
